(19) United States
(12) Patent Application Publication
(10) Pub. No.: US 2009/0037312 A1
(43) Pub. Date: Feb. 5, 2009

(54) Investment Method for Incentivizing Economic Development

(76) Inventor: Carl H. Freyer, Old Greenwich, CT (US)

Correspondence Address: LUEDEKA, NEELY & GRAHAM, P.C., P O BOX 1871, KNOXVILLE, TN, 37901, US

(21) Appl. No.: 12/185,559

(22) Filed: Aug. 4, 2008

Related U.S. Application Data
(60) Provisional application No. 60/953,918, filed on Aug. 3, 2007.

(51) Int. Cl. G06Q 40/00

(52) U.S. Cl. 705/35

(57) ABSTRACT

A method for managing an account to produce tax money for the benefit of a sponsoring entity and a designated beneficiary entity. A beneficiary account is designated into which an owner of an original corpus of funds transfers such funds. The beneficiary account produces a growth and/or income to which no or a reduced or deferred rate of first taxation is applied. A second tax is periodically assessed against all or part of the original corpus of funds. The second tax may be paid to the sponsoring entity or the beneficiary entity or split between both entities.

The invention relates to a method or system for managing deferred income investment accounts or “DIIA”s (e.g., so-called pension, IRA, 401k, or other “retirement” accounts) to create income for sponsoring and target beneficiary entities. As used herein, a DIIA is an account wherein fees or other charges normally assessed against or related to invested monies, growth, and/or appreciation are reduced and/or deferred. Such fees can include any of an assortment of fees or charges directly or indirectly assessed against the owner or other party by contract, statute, or other obligation including, for example, fees, taxes, duties, and the like (hereinafter collectively “fees”) under state and/or federal taxation regulations, international treaties or agreements, bank account service fees, financial institution investment management, escrow, or other fees, and licensing requirements.

In accordance with one embodiment of the method, an investor, owner, controller or other responsible party (“hereinafter collectively” owner) of a corpus of money or other valuable assets may place or associate the same with a new type of account associated with a target beneficiary entity, or designated beneficiary account (“DBA”), such as a nonprofit organization entity or a governmental entity for any desired purpose such as to raise funds for economic or community development. Thus, to incentivize investment in a DBA, a sponsoring entity may agree to reduce, defer, cancel, or otherwise discount various fees due to the sponsoring entity or other obligee by the owner or other obligor. For example, the federal government may agree not to collect and/or to defer any federal income tax or other fee on any income or growth in a DBA account.

The owner of an existing DIIA may be allowed an opportunity to convert the existing DIIA, such as an IRA or 401(k), into a DBA account. According to one embodiment, an owner of a DIIA may only be given a single opportunity to make such a conversion to a DBA or may be allowed multiple opportunities to convert all or part of an existing DIIA into a DBA. Additionally, in some embodiments, an owner may be allowed to make contributions into a DBA from non-DIIA accounts.

The DBA may be managed by one or more bonded, fiduciary private and/or governmental money managers or other management entities (hereinafter collectively “managers”) who may manage the types of investments and also collect and distribute assessed fees on the account periodically. The manager may be fully responsible for managing the DBA investments. However, in certain embodiments, the sponsoring entity and/or beneficiary entity may direct the manager as to the types of investments available for investment of the DBA corpus and/or the owner may specify particular investments, such as specific mutual finds, for the DBA corpus. The managers may be approved by the target beneficiary entity and/or sponsoring entity, such as the federal government. The manager's fees may be paid by the owner, the target beneficiary entity, and/or the sponsoring entity. The manager's fees may be paid directly or indirectly, such as by collection from a portion of the DBA corpus or by withholding or otherwise collecting from fees assessed by the beneficiary entity and/or sponsoring entity.

In the DBA, the corpus or originally designated amount is preferably assessed a fee on a regular basis, such as yearly, while any appreciation, growth, dividends, or other income is allowed to accumulate in the DBA and/or be paid as directed, fee-free. The corpus is preferably assessed at a certain relatively low percentage, such as 1%, on an annual basis or other periodic basis over time. The periodic fee may be assessed for a predetermined number of years, such as on an annual basis against the original corpus amount for, say, a 30-year period, the annual fee may be assessed so long as the corpus (or any permitted portion thereof) remains in the DBA, or the annual fee may be assessed until the owner reaches a certain age or some other event occurs. However, monies accumulated or reinvested in the DBA as a result of appreciation, growth, dividends, or other income are preferably not assessed at all, or are assessed at some reduced rate. For example, an investor may be required to pay an annual fee of 1% of the original corpus amount transferred into the DBA. Assuming a $100,000 investment was initially placed in the DBA as the corpus, the annual fee would be $1,000, even if the investment grew in total value during the year. For example, if the initial corpus of $100,000 appreciated to $110,000, the annual fee would still be $1,000. There would be no fee, such as federal income tax, assessed against the $10,000 appreciation.

In addition to the above, there may be limitations on the owner's rights to remove assets from at least the original corpus part of the DBA. For example, an owner may be required to maintain all original corpus monies in the DBA for a certain period of time, such as thirty years, to insure sponsoring entities and beneficiary entities a certain return over time. However, in certain embodiments, after the predetermined time limitation has elapsed, the investor may withdraw all or part of the corpus from the DBA without paying any additional fees on the original corpus or growth/appreciation, such as federal income taxes, or the owner may be allowed to withdraw all or part of the corpus for payment of a graduated withdrawal fee.

Any early withdrawal may result in a fee, such as an acceleration of all or part of the expected per annum fee payments and/or an additional fee. In one example, assuming a $100,000 initial balance in a target DBA, with a thirty year limitation on withdrawals, a withdrawal of the entire corpus of the account in year 25 can, for example, obligate the owner/investor to pay a fee of $6,000: 1% for year 25 and 5% for the remaining five years, for a total of 6%. Additionally, for example, all or part of growth monies may be included in an investor's gross income and subject to federal income taxation as a fee or disincentive against withdrawal of all or part of the corpus.

The periodic fee assessed against the DBA is preferably shared in some fixed, fluctuating, and/or sliding scale proportion between the beneficiary entity (e.g., the Virgin Islands) and the sponsoring entity (e.g. the federal government), for example a total of 1% per year, split 50/50. In other embodiments, the beneficiary entity may retain all fees assessed in certain years (e.g. years 1-10) and the sponsoring entity may retain the fees in other years (e.g. years 11-30). In further embodiments, the allocation proportion may change year to year according to a set schedule or otherwise phase, fluctuate, convert, and/or reallocate depending on one or more defined or predesignated factors, and/or according to an agreed periodicity, or in other respects. A designated escrow agent, preferably under suitable bond together with appropriate other/additional security, may collect and distribute all fees, for example from the manager (also preferably under bond with appropriate security), and may prepare/release all reports/accounting data.

The beneficiary entity may, in some embodiments, assign, pledge, and/or subrogate its rights to the fee income to a financial institution or other entity in return for an advance, lump sum, or other preferred payment schedule (typically discounted), of all or part of its projected income, which the beneficiary entity may then use immediately or otherwise at its discretion for various activities, such as community and/or economic development, infrastructure improvements, or the like. The assessments against the corpus over time may be guaranteed by the full faith and credit of the sponsoring entity or other suitable entity, and all aspects of the system and its governance controlled by the enactment of suitable rules, statutes, laws, and/or regulations, as necessary. Additionally, the beneficiary account will be revenue positive for the sponsoring entity in many embodiments of the invention, thereby providing monetary benefits to the beneficiary entity and sponsoring entity, while also providing investors a unique option for investing in a DIIA.

The foregoing description of preferred embodiments for this invention has been presented for purposes of illustration and description. It is not intended to be exhaustive or to limit the invention to the precise form disclosed. Any/all obvious and other modifications or variations of the system described herein are intended to be encompassed within claims drawn to particularly point out and distinctly claim the same, in light of the above teachings. The embodiments described herein are an effort to provide the best known illustrations of the principles of the invention and its practical application, and to thereby enable one of ordinary skill in the art to utilize the invention in various known and future envisioned embodiments and with various modifications as are suited to the particular use contemplated. All such and any other modifications and variations are within the scope of the invention as defined by the appended claims when interpreted in accordance with the breadth to which they are fairly, legally, and equitably entitled.

What is claimed is:

1. A method for managing an account to produce income for the benefit of a designated beneficiary entity comprising the steps of a) designating a beneficiary account into which an owner of an original corpus of assets may transfer such assets, b) funding the account with the original corpus of assets, c) managing the account to produce a growth and/or income to which no or a reduced or deferred first sponsoring entity fee is applied, d) collecting a second fee periodically against all or part of the entire corpus of funds, and e) paying at least a first portion of the second fee to the sponsoring entity and a second portion of the second fee to the beneficiary entity.

2. The method of claim 1, wherein the transfer of the original corpus to the beneficiary account is a requirement for the first sponsoring entity fee to be reduced, deferred, or cancelled.

3. The method of claim 1, wherein the second fee is collected against the original corpus of funds and the second fee is not collected against any growth or income.

4. The method of claim 3, wherein a third fee which is less than the second fee is collected against any growth or income.

5. The method of claim 1, wherein the periodic second fee collections are split to pay the first portion to the sponsoring entity and the second portion to the beneficiary entity.

6. The method of claim 1, wherein a first set of the periodic second fee collections are paid substantially entirely to the sponsoring entity and a second set of periodic second fee collections are paid substantially entirely to the beneficiary entity.

7. The method of claim 1, further comprising the step of collecting an early withdrawal fee if a portion of the entire corpus is withdrawn from the beneficiary account prior to a predetermined period of time.

8. The method of claim 7, wherein the early withdrawal fee comprises federal taxation on growth or income.

9. The method of claim 7, wherein the early withdrawal fee comprises accelerated collection of periodic second fee payments.

10. The method of claim 1, wherein the first sponsoring entity fee assessment comprises federal income taxation.

11. The method of claim 1, wherein the second fee collection and distribution are performed by a manager.

12. The method of claim 1, further comprising the step of the beneficiary entity subrogating the second portion of the second fee to a subrogation entity for an advance payment from the subrogation entity.

13. The method of claim 1, wherein the original corpus is transferred from a first deferred income investment account.

14. The method of claim 1, wherein the owner of the original corpus may only make a single transfer of assets into the beneficiary account.

15. A method for managing an account to produce income for the benefit of a designated beneficiary entity comprising the steps of a) designating a beneficiary account into which an owner of an original corpus of assets may transfer such assets, b) finding the account with the original corpus of assets, c) managing the account to produce a growth and/or income to which no or a reduced or deferred first sponsoring entity fee is applied, d) collecting a second fee periodically against all or part of the entire corpus of funds, and e) paying at least a first portion of the second fee to the beneficiary entity.

16. The method of claim 15, wherein a second portion of the second fee is paid to the sponsoring entity.

17. The method of claim 15, wherein the sponsoring entity is the federal government and the first sponsoring entity fee is federal income taxation.

18. The method of claim 15, further comprising the step of the beneficiary entity subrogating the second portion of the second fee to a subrogation entity in return for an advance payment from the subrogation entity.

19. The method of claim 15, wherein the transfer of the original corpus to the beneficiary account is a requirement for the first sponsoring entity fee to be reduced, deferred, or cancelled.
